(19) United States
(12) Patent Application Publication
(10) Pub. No.: US 2020/0392741 A1
(43) Pub. Date: Dec. 17, 2020

(54) LAMINATED PANE HAVING ALL-AROUND SEALING

(71) Applicant: SAINT-GOBAIN GLASS FRANCE, COURBEVOIE (FR)

(72) Inventors: Marcus NEANDER, ESCHWEILER (DE); Manfred GILLISSEN, HERZOGENRATH (DE)

(21) Appl. No.: 16/954,922

(22) PCT Filed: Nov. 23, 2018
(86) PCT No.: PCT/EP2018/082340

§ 371 Date: Jun. 17, 2020

(30) Foreign Application Priority Data
Dec. 20, 2017 (EP) 17208792.6

(51) Int. Cl. E04F 13/14; B32B 17/10; B32B 27/20; B32B 27/30; B32B 27/40; B32B 3/06; B32B 7/12; B32B 9/00

(52) U.S. Cl. CPC E04F 13/145; B32B 2250/40; B32B 17/1077; B32B 27/20; B32B 27/306; B32B 27/40; B32B 3/06; B32B 7/12; B32B 9/002; B32B 17/10018; B32B 17/10715; B32B 17/10788; B32B 2250/02; B32B 2250/03; B32B 2255/10; B32B 2307/41; B32B 2307/412; B32B 2307/414; B32B 2307/7265; B32B 2307/732; B32B 2419/00; B32B 17/10302

(57) ABSTRACT

A laminated pane has two primary surfaces and a surrounding edge surface, containing the following, positioned atop one another in the order indicated and adhesively bonded to one another, a transparent glass panel, a transparent adhesion-promoting layer, a mechanically stable layer, and an all-around sealing of the surrounding edge surface, wherein the all-around sealing has at least three polymer layers of different materials, wherein a first polymer layer of the three polymer layers is a first adhesive film that is adhesively bonded at its boundary layer to the surrounding edge surface of the laminated pane, a second polymer layer of the three polymer layers is a second adhesive film that is provided for bonding the first adhesive film to a third polymer layer, and the third polymer layer of the three polymer layers is a barrier film that forms a barrier to liquid.

The invention relates to a laminated pane, a method for production thereof, and use thereof.

Known from the German patent application DE102008052066A1 is an article that contains a panel-shaped composite material having two primary surfaces and a surrounding edge surface. The panel-shaped composite material contains, in the order indicated, positioned one atop another and adhesively bonded to one another, a first mechanically stable, transparent layer, a first transparent, tear-resistant, adhesion-promoting layer, an opaque or translucent stone layer that is substantially or completely free of volatile compounds, a second transparent, tear-resistant, adhesion-promoting layer, and a second mechanically stable, transparent layer, and an all-around sealing of the surrounding edge surface that contains a cured casting resin or a tear-resistant adhesive film.

The tear-resistant adhesive film is preferably polyvinyl butyral, PVB, polyethylene vinyl acetate, EVA (ethylene vinyl acetate), polyethylene terephthalate, PET (polyethylene terephthalate), polyvinyl chloride, PVC, ionomer resin based on ethylene and/or propylene and alpha,beta-unsaturated carboxylic acids or polyurethane, PU and preferably contains at least one filler.

Furthermore, the sealing can include a black edge band, which is applied to the edge after the assembly of the individual components and subsequently passes through the same bonding process that is necessary to produce the laminate.

The object of the present invention is to provide a laminated pane that has an improved edge sealing and is simpler and, thus, more economical to produce.

The objects of the present invention are accomplished by a laminated pane according to claim 1, a method according to claim 10, and a use according to claim 13. Preferred embodiments are apparent from the dependent claims.

The laminated pane according to the invention having two primary surfaces and a surrounding edge surface contains, in the order indicated, positioned one atop another and adhesively bonded to one another,
a transparent glass panel,
a transparent adhesion-promoting layer,
a mechanically stable layer, and
an all-around sealing of the surrounding edge surface that has at least three polymer layers of different materials, wherein
   a first polymer layer of the three polymer layers is a first adhesive film that is adhesively bonded at its boundary layer to the surrounding edge surface of the laminated pane,
   a second polymer layer of the three polymer layers is a second adhesive film that is provided for bonding the first adhesive film to a third polymer layer, and
   the third polymer layer of the three polymer layers is a barrier film that forms a barrier to liquid.

Surprisingly, it has been found that the easily producible laminated pane according to the invention with an all-around sealing that has three polymer layers significantly improves the leak-tightness of the sealing. Furthermore, with the use of at least one electively colored polymer layer, it is possible to provide the all-around sealing with a desired coloring and, thus, to also create an optically appealing all-around sealing. Coloring by using at least one colored polymer layer also represents an optically neutral all-around sealing since the all-around sealing can be adapted in accordance with the wishes of the user or manufacturer and thus, with its adjustable appearance, blends harmoniously into its surroundings.

The mechanically stable layer can be implemented as a translucent or opaque stone layer. The laminated pane is preferably also translucent or opaque. Preferably, the stone layer of the laminated pane according to the invention is translucent. Alternatively, the the mechanically stable layer can also be partially or completely transparent.

To differentiate from transparency, translucence can be described as permeability to light and transparency as permeability to image or vision. Opacity is the reciprocal property to translucence. If an object has high transparency, it has low opacity, and vice versa.

The laminated pane according to the invention can, in addition to its two primary surfaces and its surrounding edge surface, contain or be connected to further functional components such as fastening devices, spacers, electrical lines, functional layers, such as protective layers or sound-damping layers, or glass panels. Moreover, it can contain recesses and/or drilled holes that can be used for decorative purposes and/or for receiving and/or for attaching functional components.

The laminated pane has a panel-shaped composite material that has, positioned one atop another in the order indicated and adhesively bonded to one another, a transparent glass panel, a transparent adhesion-promoting layer, and a mechanically stable layer, and the surrounding edge surface has the all-around sealing. The expression “panel-shaped” means that the primary surfaces of the composite material or of the laminated pane have a larger surface area than the surrounding edge surface. Preferably, the relationship of the area of a primary surface to the area of the surrounding edge surface is >1, preferably >2, and in particular >3.

The laminated pane is preferably nearly or, within measuring accuracy, exactly planar. In the present invention, the expression “nearly planar” means that the composite material is curved in one or more spatial directions in the per-thousand range or by a few percent. The bending must not be so strong that the stability limit of the stone layer is exceeded and the stone layer breaks or cracks.

The laminated pane can have any outline. For example, the outline can be angular and/or rounded. Examples of angular shapes are squares, rectangles, diamonds, triangles, pentagons, hexagons, or stars. Examples of rounded shapes are circles or ellipses. The individual elements of these shapes can also be combined with one another resulting, for example, in square or circular panel-shaped composite materials whose edge describes a wavy line. The above-described shapes substantially or exactly define the shapes of the laminated panes according to the invention.

In a preferred embodiment, the laminated pane is translucent and consists of or contains
a first mechanically stable transparent glass panel,
a first transparent adhesion-promoting layer,
a translucent stone layer,

that are positioned one atop the other in the order indicated and are adhesively bonded to one another. Here, the expression “mechanically stable” means that the layer is not damaged within broad temperature limits even under the influence of mechanical forces, as are generated, for example, by prolonged pressure, by short hard blows, or by friction, but, instead, retains its integrity and shape.

In the present invention, the term “transparent” means that the layer in question is image-permeable or vision-permeable. This is especially the case when the layer in question has visible light transmittance of >50%, preferably >70%, and in particular >80%.

The essential component of the laminated pane according to the invention is the all-around sealing that completely covers the surrounding edge surface and is adhesively bonded thereto, has or consists of three polymer layers of different materials. A first polymer layer of the three polymer layers is a first adhesive film, which is adhesively bonded at its boundary layer to the surrounding edge surface of the laminated pane; the second polymer layer is a second adhesive film, which is provided for bonding the first adhesive film to a third polymer layer; and the third polymer layer is a barrier film that forms a barrier to liquid. In particular, as a result of this, the mechanically stable layer can be at least partially or completely protected against environmental influences, and the long-term adhesion of the all-around sealing to the panel-shaped composite material is ensured.

A material of the first and second adhesive film is preferably selected from PE (polyethylene), PU (polyurethane), and/or EVA (ethylene vinyl acetate). A material of the barrier film is preferably PET (polyethylene terephthalate). The PU used as the adhesive film is more preferably a TPU (thermoplastic polyurethane). Particularly preferably, the first adhesive film has EVA, the second adhesive film PE, and the barrier film PET. Such a film composite is, per se, particularly stable and has very good adhesive properties.

Advantageously, as a second adhesive film, PE forms a particularly adhesive bond between the first adhesive film and the barrier film.

Preferably, the all-around sealing has the same thickness everywhere. The thickness of the all-around sealing can vary from case to case and thus be optimally adapted to the requirements of the individual case. Preferably, a layer thickness of the barrier film is in the range from 0.05 to 0.20 mm, preferably 0.08 to 0.17 mm, more preferably 0.10 to 0.15 mm. A layer thickness of the first adhesive film is preferably in the range from 0.05 to 0.250 mm, preferably 0.06 to 0.1 mm. A layer thickness of the second adhesive film is preferably in the range from 0.02 to 0.07 mm, preferably 0.04 to 0.06 mm.

A width of the all-around sealing preferably is or substantially equals the thickness of the panel-shaped composite material, which is made up of the layer thickness of the glass, adhesion promoter, and stone layers positioned one atop another and bonded to one another. A length of the all-around sealing preferably is or substantially equals the perimeter of the panel-shaped composite materials, which is, for example, in the case of a polygon, the sum of the lengths of the sides, or in the case of a circle, can be calculated from a diameter or radius of the circle. The surrounding edge surface is, consequently, preferably completely or substantially completely provided with the all-around sealing or covered by it.

Preferably, the barrier film has a coating. Alternatively, or additionally, the barrier film can contain a dye. Also, alternatively, or additionally, the barrier film can have printing. By means of the dye or the printing, a desired coloration or patterning can be achieved with the laminated pane. The coating is preferably implemented as a barrier coating that forms a barrier to liquid, preferably a barrier to water. Silicon dioxide, silicon nitride, and/or titanium oxide, for example, can be considered as coating materials. The coating can further protect the laminated pane against environmental influences.

Preferably, the three polymer layers are transparent. In this case, the color and the structure of the stone layer are visible all the way to the edge of the laminated pane.

Preferably, the polymer layers of the all-around sealing are tear-resistant. Furthermore, at least one of the polymer layers of the all-around sealing preferably contains at least one filler. All customary and better-known organic and inorganic fillers per DIN 55943: 1993-11 and DIN EN 971-1:1996-09 can be considered as fillers. The filler content of the all-around sealing can vary widely and thus be adapted to the requirements of the individual case. Preferably, the content is 5 to 50 wt.-%, preferably 7.5 to 45 wt.-%, particularly preferably 10 to 40 wt.-%, and in particular 12.5 to 35 wt.-%, in each case based on the total amount of the all-around sealing.

If necessary, the laminated pane preferably has further layers. Preferably, a further transparent adhesion-promoting layer is arranged on the side of the translucent or opaque stone layer facing away from the transparent adhesion-promoting layer, and a further transparent glass panel is arranged on the side of the transparent adhesion-promoting layer facing away from the translucent or opaque stone layer. Alternatively preferably, a seal is, if necessary, arranged on the side of the translucent or opaque stone layer facing away from the transparent adhesion-promoting layer. The seal is preferably applied directly onto the stone layer. However, even indirect sealing via a mediating layer between the stone layer and the sealing is possible. The seal is functionally defined in particular by its impermeability to moisture.

Preferably, the further transparent adhesion-promoting layer is tear-resistant. The transparent adhesion-promoting layer and the further transparent adhesion-promoting layer can be the same or different from one another, in other words, they can be made of the same materials or of different materials and/or have different thicknesses. Here, the thicknesses can also vary widely and thus be adapted to the requirements of the individual case. Preferably, the adhesion-promoting layers are in each case 0.4 to 10 mm, preferably 0.5 to 8 mm, particularly preferably 0.6 to 6 mm, and in particular 0.7 to 4 mm thick. If two adhesion promoting layers are used, they preferably have the same thickness.

Preferably, the further transparent glass panel is mechanically stable. In principle, the transparent glass panel and in the case of double construction with two glass panels, the further transparent glass panel can be the same or different from one another, in other words, they can be made of the same material or of different materials and/or have different thicknesses. The thicknesses can vary widely and thus the adapted to the requirements of the individual case. Preferably, the layers are 2 to 50 mm, preferably 2 to 40 mm, particularly preferably 2 to 30 mm, and in particular 2 to 25 mm thick.

Furthermore, at least one of the adhesion promoter, glass, and/or stone layers of the laminated pane can consist of at least two plies of at least two different materials. Essential for the selection of the materials is the fact that the layer in question has the above-described required property profile. In particular, the at least two plies must be permanently adhesively bonded to one another and to the adjacent layers.

In principle, all materials that have the above-described required property profile can be considered as materials for the production of the transparent glass panel and, optionally, the other glass panel. Preferably, the materials are selected from the group consisting of colored and uncolored glasses, colored and uncolored, rigid, clear plastics that are provided with a barrier layer against vapor diffusion. Preferably, colored and uncolored glasses are selected.

Preferably, the colored and uncolored glass is selected from the group consisting of colored and uncolored, non-toughened, partially toughened, and toughened float glass, cast glass, ceramic glass, and glass. Float glass is particularly preferred.

In principle, all materials that have the above-described required property profile can be considered as materials for the production of the adhesion-promoting layer and, optionally, another adhesion promoting layer. Preferably, the material is selected from the group consisting of casting resins cured thermally and/or with actinic radiation and tear-resistant adhesive films. As is known, thermally cured casting resins are produced from thermally curable casting resins that contain complementary reactive functional groups that react with one another under the influence of thermal energy such that a three-dimensional network is formed in the cured casting resin. Examples of suitable thermally curable casting resins are epoxy resins. As is known, casting resins cured with actinic radiation are produced from casting resins that contain reactive functional groups that polymerize anionically, cationically, or radically, in particular, radically. The reactive functional groups are, in particular, olefinically unsaturated double bonds. Electromagnetic radiation, such as near infrared (NIR), visible light, UV radiation, X-rays, and gamma radiation; or corpuscular radiation, such as electron radiation, proton radiation, beta radiation, or alpha radiation, can be considered as actinic radiation. The casting resins can contain customary, known adhesion promoters, as described in the European patent application EP0799949A1, column 6, lines 24 to 32. Preferably, the tear-resistant adhesive films are selected from the group consisting of polyvinyl butyral PVB, polyethylene-vinyl acetate EVA, polyethylene terephthalate PET, polyvinyl chloride PVC, ionomer resins based on ethylene and/or propylene, and alpha,beta-unsaturated carboxylic acids or polyurethane, PU. Polyurethane films are used in particular.

All types of natural and synthetic stones that can be produced in thin layers can, in principle, be considered as materials for producing the translucent or opaque stone layer. The thickness of the stone layer can vary widely and thus be adapted to the requirements of the individual case. The thickness is governed, in particular, by the desired transparency or opacity, the mechanical stability, and the morphology of the stone. Preferably, the thickness is 1 to 20 millimeters, preferably 1.5 to 15 mm, and in particular 2 to 10 mm. Examples of particularly well-suited natural stones are granite, gneiss, limestone, crystalline marble, onyx, and semiprecious stones. As already mentioned above, the stone layer can also consist of at least two layers that are adhesively bonded to one another. For this purpose, the above-described transparent adhesion-promoting layers can be used. In this embodiment, the laminated pane has two optically different sides, thus offering additional design possibilities within the scope of the use according to the invention. However, for reasons of simplicity of manufacture and handling, single-layer stone layers are preferred. In addition, the stone layer can be composed of different stones, yielding an ornamental or mosaic-like structure in the surface. Preferably, the individual stone parts are adhesively bonded to one another.

Preferably, the translucent or opaque stone layer is substantially or completely free of volatile compounds. In the context of the present invention, the term “volatile” means that the compound in question has comparatively high vapor pressure, for example, vapor pressure >10 kPa, even at comparatively low temperatures, for example, temperatures <150° C. At room temperature, the volatile compounds can be liquid, solid, and gaseous inorganic and organic compounds. The volatile compounds can be natural constituents of the stones, decomposition products of constituents, and/or residues and/or decomposition products of processing aids customarily used in the production of synthetic stones or during cutting, grinding, and polishing of the stones. Examples of such volatile compounds are carbon dioxide, hydrogen sulfide, ammonia, carbonates, sulfides, organic and inorganic acids, organic solvents, monomers, or water. The volatile compound is mainly water.

In the context of the present invention, the term “substantially free” means that the translucent or opaque stone layer has such a low content of volatile compounds that when the laminated panes are used according to the invention, only a slight dynamic pressure builds up, which can no longer damage the laminated pane even long-term over many years.

When the volatile compound is water, the water content of the translucent or opaque stone layer, based on the total amount thereof, is preferably <1 wt.-%, preferably <0.5 wt.-%, and in particular <0.1 wt.-%.

In the context of the invention, the term “completely free” means that the volatile compound content of the translucent or opaque stone layer is so low that it is less than the detection limit.

Due to its structure, the laminated pane has a surrounding edge surface whose contour can vary both from composite material to composite material and even for one and the same composite material in subregions of the overall perimeter. Thus, the surrounding edge surface, viewed in cross-section, can form an angle of 90° with the two primary surfaces, in each case, at least in part of its overall perimeter. However, it can also be beveled at least in part of the overall perimeter such that it forms, viewed in cross-section, an angle >90° with one primary surface and an angle <90° with the other primary surface. However, it can also have, viewed in cross-section, a round or angular, convex or concave contour, at least in part of the overall perimeter.

Preferably, in its overall perimeter, the surrounding edge surface forms an angle of 90° with the two primary surfaces in each case.

The laminated pane according to the invention can be produced in a manner known per se. Preferably, however, it is produced using the method according to the invention.

The invention relates to a method for producing a laminated pane described above, in which

(I) a mechanically stable layer is adhesively bonded to a transparent glass panel via a transparent adhesion-promoting layer, and

(II) the surrounding edge surface is sealed with an all-around sealing that has at least three polymer layers of different materials.

Preferably, steps (I) and (II) are carried out simultaneously under heat treatment. This simplifies production since laminating and sealing are produced in a single step both over the surface and along the edges of the laminated pane. Furthermore, with the suitable selection of the polymer layer system for the edge sealing, the advantage consists in that an optically neutral edge is provided in a single step. In addition, such an all-around sealing offers the advantage that little or no subsequent work on the edges of the laminated pane is required.

For example, the laminated pane is produced by a temperature process in an autoclave. The steps (I) and (II) are preferably carried out without pressure.

Preferably, the mechanically stable layer is an opaque or translucent stone layer and, in step (I), is further adhesively bonded to another transparent glass panel on the side facing away from the adhesion-promoting layer via a further transparent adhesion-promoting layer. Alternatively, in step (I), the stone layer is preferably further sealed by means of a side facing away from the adhesion-promoting layer.

In an advantageous embodiment, a translucent or opaque stone layer of the desired thickness is first prepared in the customary, known manner, for example, using the method known from the American U.S. Pat. No. 4,177,789. Preferably, for further processing, the translucent stone layer is joined to a temporary carrier from which it can easily be removed again.

Before carrying out the first step of the method according to the invention, the translucent or opaque stone layer can still be ground, polished, and/or freed of adhering impurities, in particular processing aids.

Within pretreatment for the method according to the invention, the translucent or opaque stone layer can be substantially or completely freed of the above-described volatile compounds. This can be done using chemical and/or physical methods, in particular physical methods. The conditions selected depend primarily on the content of volatile compounds in the translucent or opaque stone layer and on its material composition and its morphology.

Preferably, for this purpose, the translucent or opaque stone layer is heated in a dry atmosphere or in a vacuum, preferably in a dry atmosphere. The thermal energy can be supplied by gaseous media, preferably the dry atmosphere itself, heating plates, heating rollers, and/or radiant heaters. Preferably, the translucent or opaque stone layer is heated until the desired maximum material temperature is reached. Preferably, the maximum material temperature >100° C. Preferably, it should not exceed 200° C., preferably 180° C., and in particular 160° C.

The heating of the translucent or opaque stone layer can be done by heating it quickly with the above-described heat sources that have the maximum material temperature.

Preferably, however, the translucent or opaque stone layer is heated gradually over a longer period of time, for example, by a ramped or stepped temperature increase. Here, it is essential to adjust the heating time such that no thermal stresses develop in the translucent or opaque stone layer.

After the desired maximum temperature is reached, the translucent or opaque stone layer is held for a relatively long time, preferably for 30 minutes to 24 hours, preferably 1 to 12 hours, and in particular 2 to 6 hours at this temperature.

Then, the translucent or opaque stone layer is cooled. Here too, it is essential to adjust the time for cooling such that no thermal stresses develop in the translucent or opaque stone layer. Preferably, the translucent or opaque stone layer is gradually cooled preferably by ramped or stepped lowering of its temperature. Preferably used as the cooling medium is a dry gaseous medium whose temperature is lowered suitably. Here, and in the following steps, care must be taken, for example, by working under a dried and cleaned atmosphere, to ensure that the transparent or opaque stone layer that is freed of volatile compounds does not again absorb volatile compounds, in particular water.

In step (I) of an advantageous embodiment, the translucent or opaque stone layer is adhesively bonded on one or both sides, via one of the above-described adhesion-promoting layers, to, in each case, one of the above-described glass panels. If the adhesion-promoting layers are produced from a casting resin that can be cured thermally and/or with actinic radiation, the casting resin can be applied at one end of a glass panel over its width in the form of a bead. Then, the glass panel is placed with this region on the stone layer, after which it nestles against the surface of the stone layer, wherein, by its own weight, it displaces the resin in front of it in a degassing manner. However, the casting resin can also be applied in the central region of the stone layer, after which a convexly curved, mechanically stable, transparent layer is placed on the casting resin and then relaxed such that the casting resin is uniformly distributed on the stone layer by the layer placed thereon. After this, the resultant casting resin layer is cured thermally and/or with actinic radiation. Then, optionally, the panel-shaped laminate comprising the stone layer, the adhesion-promoting layer and the glass panel is turned over on the other side and, if necessary, the exposed side of the stone layer can be provided with further adhesion-promoter and glass panels in the same manner as described above or a sealant can be provided.

When the adhesion-promoting layers are produced from the above-described adhesive film, all layers of the laminated pane are placed one atop the other in a precisely fitting manner. Then, the air between the layers is removed in a suitable apparatus, for example, in a vacuum bag, by applying a vacuum, wherein the external air pressure of 100 kPa presses the layers together. Preferably, this step is carried out at a temperature >50° C. Then, the resultant composite material can still be post-treated at temperatures up to 150° C. with a uniformly acting pressure >100 kPa, for example, in an autoclave. The layers placed one atop another can, however, also be pre-laminated at a temperature >50° C., for example, 70° C., and a pressure >100 kPa, for example, 700 kPa, after which the layers of the resultant pre-laminate are adhesively bonded to one another at a uniformly acting pressure >100 kPa, for example, 1,200 kPa, and at a temperature >100° C., for example, 135° C., in an autoclave.

Preferably, the adhesion-promoting layers are produced from tear-resistant, transparent adhesive film.

The surrounding edge surface of the resultant panel-shaped composite material is provided, in step (II), with the all-around sealing. The all-around sealing is produced from the above-described materials. Preferably, the polymer layers are produced in the desired thicknesses. The polymer layers are adhesively bonded to the edge surface either individually or together in the form of a band of a width at least equal to the width of the surrounding edge surface.

Preferably, these polymer layers are laminated together with the glass panel and the stone layer in a common step. Optionally, excess material of the all-around sealing that protrudes beyond the level of one or both primary surfaces can subsequently be removed.

The laminated pane according to the invention, in particular the laminated pane produced using the above-described method according to the invention, has particular advantages and can, consequently, be used in a variety of ways. It can be used particularly well in the context of the use according to the invention as a novel purely decorative and/or decorative-architectural article and/or as a novel purely decorative and/or decorative-architectural component for indoors or outdoors. Or, it can be used for the production of such a new article or such a new component. When the stone layer of the laminated pane is exposed, the laminated pane is, preferably, suitable for indoor use. When the stone layer is covered on both sides, the laminated pane is suitable for indoor and outdoor applications.

The term “decorative-architectural” means that the article or the component has a structural or functional property in or on a section of a building in addition to a decorative effect.

Examples of such new articles and new components are purely decorative or decorative-architectural components for indoors or outdoors, in particular interior or exterior cladding of buildings, such as exterior façades or interior walls. However, the laminated pane according to the invention or the laminated pane produced by the method according to the invention can also be used as cladding for door leaves, covering for lights, load-bearing furniture components, such as tabletops or worktops, for example, in kitchens, a component for covering roofs, or a privacy screen element for railings.

In the following, exemplary embodiments of the laminated pane according to the invention are explained by way of example with reference to the following figures. The schematic representations are not to scale. The proportions shown do not, consequently, correspond to the proportions used in implementation of the invention in practice. They depict:

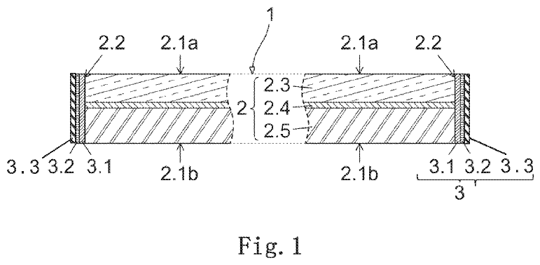

FIG. 1 a schematic cross-sectional view of a laminated pane according to the invention according to a first embodiment;

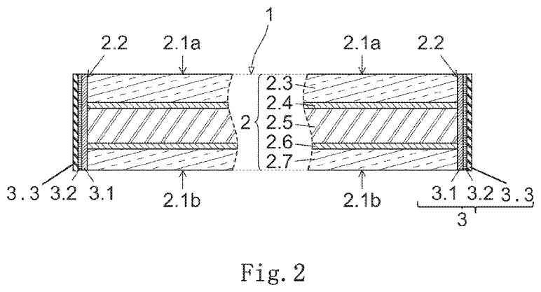

FIG. 2 a schematic cross-sectional view of a laminated pane according to the invention according to a second embodiment;

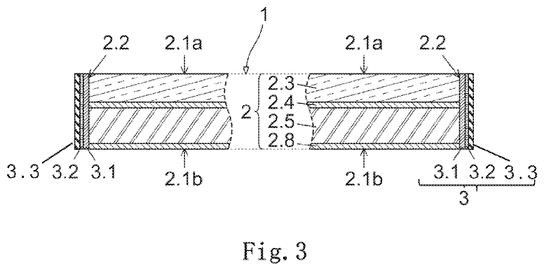

FIG. 3 a schematic cross-sectional view of a laminated pane according to the invention according to a third embodiment; and

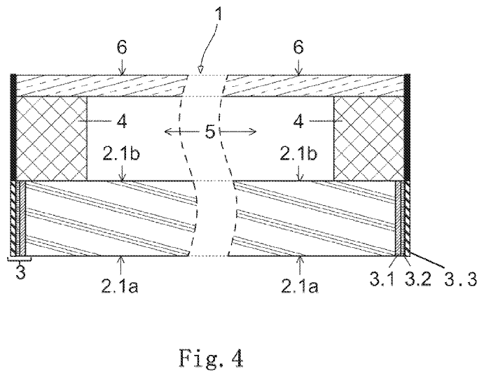

FIG. 4 a schematic cross-sectional view of a laminated pane according to the invention in the form of a multiple insulating glass containing a laminated pane per FIGS. 1 to 3.

FIG. 1 depicts a schematic cross-sectional view of a laminated pane according to the invention according to a first embodiment.

A preferred first embodiment of the laminated pane 1 according to the invention of FIG. 1, which does not restrict the invention, is, for example, a decorative translucent cladding for an interior wall.

The laminated pane 1 comprises a panel-shaped composite material 2 having two primary surfaces 2.1a and 2.1b and a surrounding edge surface 2.2 forming the edge of the laminated pane 1, which is covered by an all-around sealing 3. Optionally, the laminated pane 1 also includes brackets, with which it can be arranged on the interior wall. For the sake of clarity, the brackets are not shown.

The composite material 2 contains, positioned atop one another in the order indicated and adhesively bonded to one another, a transparent glass panel 2.3, a transparent adhesion-promoting layer 2.4, and a mechanically stable layer implemented as a translucent or opaque stone layer 2.5. The all-around sealing 3 of the surrounding edge surface 2.2 has a first polymer layer 3.1 in the form of a first adhesive film, a second polymer layer 3.2 in the form of a second adhesive film, and a third polymer layer 3.3 in the form of a barrier film forming a barrier to liquid.

The transparent glass panel 2.3 is a transparent glass panel of dimensions 300 mm×300 mm, a thickness of 4 mm, and visible light transmittance of 90%. The outer surface of the transparent glass panel 2.3 forms the primary surface 2.1a, while the outer surface of the translucent or opaque stone layer 2.5 forms the other primary surface 2.1b.

The translucent or opaque stone layer 2.5 is, in this exemplary embodiment, a 5-mm-thick translucent marble panel that has the same dimensions as the transparent glass panel 2.3. The translucent stone layer 2.5 is completely free of volatile compounds. It is, in particular, free of water. It is bonded to the transparent glass panel 2.3 via the transparent adhesion-promoting layer 2.4. The transparent adhesion-promoting layer 2.4 is a 0.8-mm-thick adhesive film made of polyurethane with the same dimensions as the translucent stone layer 2.5 and the transparent glass panel 2.3.

The panel-shaped, translucent composite material 2 of the laminated pane 1 is a total of 9.8-mm-thick, which corresponds exactly to the width of the surrounding edge surface 2.2. Its length is 1,200 mm and its total surface area is 0.01176 m². The ratio of the area of a primary surface 2.1a or 2.1b to the area of the surrounding edge surface 2.2 is consequently about 8:1. Viewed in cross-section, the surrounding edge surface 2.2 forms an angle of 90° with the two primary surfaces 2.1a and 2.1b in each case.

The surrounding edge surface 2.2 covered with the all-around sealing 3, which is formed by a 0.06-mm-thick band of a polymer layer 3.1 made of EVA bonded to the surrounding edge surface 2.2 and a second polymer layer 3.2 made of PE arranged on the side of the polymer layer 3.1 facing away from the edge surface 2.2. A third polymer layer 3.3 made of PET covers the second polymer layer 3.2, which forms an adhesive bond between the first polymer layer 3.1 and the third polymer layer 3.3.

The laminated pane 1 is produced by first subjecting the translucent stone layer 2.5 to a pre-treatment. The translucent stone layer 2.5 of dimensions 300 mm×300 mm×5 mm is polished on its surfaces. Then, any solid residues from the polishing are removed with compressed air. After that, the translucent stone layer 2.5 is rinsed with deionized water and pre-dried. The pre-dried, translucent stone layer 2.5 is freed of volatile compounds, in particular, of water, in a circulating-air oven that is operated with cleaned, dried air, at a maximum material temperature of 140° C. Then, the translucent stone layer 2.5 free of volatile compounds is gradually cooled to room temperature.

Then, in the order indicated, the polished, cleaned, and dried transparent glass panel 2.3 of dimensions 300 mm×300 mm×4 mm, the transparent adhesion-promoting layer 2.4 of dimensions 300 mm×300 mm×0.8 mm, and the translucent stone layer 2.5 free of volatile compounds are placed one atop another in a precisely fitting manner.

Subsequently, the surrounding edge surface 2.2 of the resultant, panel-shaped, translucent composite material 2 is bonded to a band with a width of 9.8 mm made of the first polymer layer 3.1 made of EVA, the second polymer layer 3.2 made of PE, and the third polymer layer 3.3 made of PET such that the surrounding edge surface 2.2 is completely covered by the all-around sealing 3.

The first polymer layer 3.1 made of EVA, the second polymer layer 3.2 made of PE, and the third polymer layer 3.3 made of PET form a so-called “film pre-laminate”, which is arranged as a band on the surrounding edge surface 2.2. The film pre-laminate can be processed without special precautionary measures and is, consequently, particularly easy to handle. The total thickness of the film pre-laminate is approx. 0.250 mm, wherein the first polymer layer 3.1 made of EVA has a film thickness of 0.06 mm, the second polymer layer 3.2 made of PE has a film thickness of 0.04 mm, and the third polymer layer 3.3 made of PET has a film thickness of 0.150 mm.

In an alternative embodiment of the film pre-laminate, the first polymer layer 3.1 made of EVA has a film thickness of 0.1 mm, the second polymer layer 3.2 made of PE has a film thickness of 0.05 mm, and the third polymer layer 3.3 made of PET has a film thickness of 0.10 mm.

The glass pane layered with the stone layer and the edge-sealing polymer layers 3.1, 3.2, 3.3 are adhesively bonded to one another in an autoclave using a heat-pressure treatment at 100° C. In a single step, simultaneously, the layers are laminated and their edges sealed.

The laminated pane 1 is of high mechanical stability and has excellent interlayer adhesion. It is, therefore, very well suited in particular for use in particular as an interior wall cladding.

FIG. 2 depicts a schematic cross-sectional view of a laminated pane according to the invention in accordance with a second embodiment. The laminated pane 1 depicted in FIG. 2 corresponds to the laminated pane 1 depicted in FIG. 1 with the difference that on the side of the translucent stone layer 2.5 facing away from the transparent adhesion-promoting layer 2.4, a further transparent adhesion-promoting layer 2.6 is arranged, and on the side of the adhesion promoting layer 2.4 facing away from the stone layer 2.5, a further transparent glass pane 2.7 is arranged such that instead of the surface of the translucent stone layer 2.5, an outer surface of the transparent glass pane 2.7 forms the primary surface 2.1b.

The further transparent glass pane 2.7 is a further transparent glass panel of dimensions 300 mm×300 mm, a thickness of 4 mm, and a visible light transmittance of 90%.

The further transparent adhesion-promoting layer 2.6 is a 0.8-mm-thick adhesive film made of polyurethane with the same dimensions as the translucent stone layer 2.5, the transparent adhesion-promoting layer 2.4, and the transparent glass panels 2.3 and 2.7.

The panel-shaped, translucent composite material 2 of the laminated pane 1 is thus 14.6-mm-thick in total, which is exactly the width of the surrounding edge surface 2.2. Its length is 1,200 mm, and its total area 0.01752 m². The ratio of the area of a primary surface 2.1a or 2.1b to the area of the surrounding edge surface 2.2 is, consequently, approx. 5:1. Viewed in cross-section, the surrounding edge surface 2.2 forms an angle of 90° with the two primary surfaces 2.1a and 2.1b in each case.

Furthermore, the surrounding edge surface 2.2 corresponding to the first embodiment is covered with the all-around sealing 3, which is formed by a band of a first polymer layer 3.1 made of EVA bonded to the surrounding edge surface 2.2, the second polymer layer 3.2 made of PE, and a third polymer layer 3.3 made of PET.

The laminated pane 1 is produced in the same way as the laminated pane depicted in FIG. 1, with the difference that the further transparent adhesion-promoting layer 2.6 of dimensions 300 mm×300 mm×0.8 mm and the further transparent glass panel 2.7 of dimensions 300 mm×300 mm×3 mm are placed on the free side of the translucent stone layer 2.5, one atop the other in the order indicated in a precisely fitting manner. The surrounding edge surface 2.2 of the resultant, panel-shaped, translucent composite materials 2 is provided with a band consisting of the first polymer layer 3.1 made of EVA, the second polymer layer made of PE, and the third polymer layer 3.3 made of PET such that the surrounding edge surface 2.2 is completely covered by the all-around sealing 3. The layers are likewise adhesively bonded to one another using the heat-pressure treatment at 100° C. in the autoclave.

The laminated pane 1 depicted in FIG. 2 is also of excellent mechanical stability and, consequently, the statements made concerning the laminated pane depicted in FIG. 1 apply accordingly.

FIG. 3 depicts a schematic cross-sectional view of a laminated pane according to the invention in accordance with a third embodiment. The laminated pane 1 depicted in FIG. 3 corresponds to the laminated pane 1 depicted in FIG. 1 with the difference that a seal 2.8 is arranged on the side of the translucent stone layer 2.5 facing away from the transparent adhesion-promoting layer 2.4 such that instead of the outer surface of the translucent stone layer 2.5, an outer surface of the seal 2.8 forms the primary surface 2.1b. The laminated pane 1 is produced by a method that corresponds to the method for producing the laminated pane depicted in FIG. 1 with the difference that the seal 2.8 is placed in a precisely fitting manner on the side of the stone layer 2.5 facing away from the transparent adhesion-promoting layer 2.4; and, then, the surrounding edge surface is provided with the all-around sealing. Alternatively, the seal can even be subsequently applied in the form of a lacquer or a resin to the outer surface of the stone layer 2.5. In this embodiment, the laminated pane is ideally suitable as an external façade cladding since the seal protects against dirt and mechanical, chemical, and thermal damage.

FIG. 4 depicts, as another preferred embodiment not restricting the invention, a schematic cross-sectional view of a laminated pane 1 in the form of a multiple insulating glass that contains a laminated pane in accordance with one of the preceding embodiments described in FIG. 1 to 3. This laminated pane 1 combines a laminated pane 1 described in FIG. 1, 2, or 3 via spacer 4 made of aluminum as is customarily used per DIN EN 1279-2 for the production of multiple insulating glasses, using a primary and a secondary adhesive (not shown) adhesively with a 3-mm-thick toughened glass pane 6 of dimensions 300 mm×300 mm such that an insulating cavity 5 results between the laminated laminated pane 1 and the glass pane 6. For the sake of clarity, in FIG. 4, the individual layers of the composite material 2 of the laminated pane 1 are no longer shown. In this configuration, the laminated pane 1 is ideally suitable for outdoor applications because the toughened glass pane 6 protects the laminated pane 1 against dirt and mechanical, chemical, and thermal damage. In addition, thermal insulation is realized such that, in particular with the use of the pane for building construction, an insulating effect is realized.

### LIST OF REFERENCE CHARACTERS

1 laminated pane,
2 composite material
2.1a first primary surface,
2.1b second primary surface,
2.2 surrounding edge surface,
2.3 glass panel,
2.4 adhesion-promoting layer,
2.5 stone layer,
2.6 further adhesion-promoting layer,
2.7 further glass panel,
2.8 seal
3 all-around sealing
3.1 first polymer layer
3.2 second polymer layer
3.3 third polymer layer
4 spacer
5 insulating cavity
6 glass panel

1. A laminated pane having two primary surfaces and a surrounding edge surface, containing the following, positioned atop one another in the order indicated and adhesively bonded to one another,
a transparent glass panel,
a transparent adhesion-promoting layer,
a mechanically stable layer, and
an all-around sealing of the surrounding edge surface,
wherein
the all-around sealing has at least three polymer layers of different materials, wherein
a first polymer layer of the three polymer layers is a first adhesive film that is adhesively bonded at its boundary layer to the surrounding edge surface of the laminated pane,
a second polymer layer of the three polymer layers is a second adhesive film that is provided for bonding the first adhesive film to a third polymer layer, and
the third polymer layer of the three polymer layers is a barrier film that forms a barrier to liquid.

2. The laminated pane according to claim 1, wherein a material of the first and second adhesive film is selected from PE (polyethylene), PU, and/or EVA (ethylene vinyl acetate) and a material of the barrier film is PET (polyethylene terephthalate).

3. The laminated pane according to claim 1, wherein a layer thickness of the barrier film is in the range from 0.05 to 0.20 mm, and a layer thickness of the first adhesive film is in the range from 0.05 to 0.250 mm, and a layer thickness of the second adhesive film is in the range from 0.02 to 0.07 mm.

4. The laminated pane according to claim 1, wherein the mechanically stable layer is an opaque or translucent stone layer.

5. The laminated pane according to claim 1, wherein the barrier film has a coating, contains a dye, and/or has printing.

6. The laminated pane according to claim 5, wherein the coating is implemented as a barrier coating.

7. The laminated pane according to claim 1, wherein the three polymer layers are transparent.

8. The laminated pane according to claim 1, comprising a further transparent adhesion-promoting layer arranged on the side of the mechanically stable layer facing away from the transparent adhesion-promoting layer, and a further transparent glass panel arranged on the side of the transparent adhesion-promoting layer facing away from the mechanically stable layer.

9. The laminated pane according to claim 1, comprising a seal arranged on the side of the mechanically stable layer facing away from the transparent adhesion-promoting layer.

10. A method for producing the laminated pane according to claim 1, comprising
(I) adhesively bonding a mechanically stable layer to a transparent glass panel via a transparent adhesion-promoting layer, and
(II) sealing the surrounding edge surface with an all-around sealing that has at least three polymer layers of different materials.

11. The method according to claim 10, wherein the steps (I) and (II) are carried out simultaneously under heat treatment.

12. The method according to claim 10, wherein the mechanically stable layer is an opaque or translucent stone layer and in step (I), is further adhesively bonded via another transparent adhesion-promoting layer to another transparent glass panel on the side facing away from the transparent adhesion-promoting layer.

13. A method comprising utilizing a laminated pane according to claim 1 as a purely decorative or decorative-architectural component for indoors or outdoors.

14. The method according to claim 13, wherein the purely decorative and/or decorative-architectural component is used as an external façade or as an internal wall cladding.

15. The laminated pane according to claim 2, wherein the PU is a TPU (thermoplastic polyurethane).

16. The laminated pane according to claim 3 wherein the layer thickness of the barrier film is in the range from 0.08 to 0.17 mm, and the layer thickness of the first adhesive film is in the range from 0.06 to 0.1 mm, and the layer thickness of the second adhesive film is in the range from 0.04 to 0.06 mm.

17. The laminated pane according to claim 16, wherein the layer thickness of the barrier film is in the range from 0.10 to 0.15 mm.
